(19) United States
(12) Patent Application Publication
(10) Pub. No.: US 2011/0215023 A1
(43) Pub. Date: Sep. 8, 2011

(54) DUAL COMPARTMENT SANDWICH CONTAINER AND METHOD OF MAKING SAME

(76) Inventors: Willard Nelson Archie, JR., Hillsborough, CA (US); Christopher Loew, Palo Alto, CA (US); David Christophe Northway, San Carlos, CA (US)

(21) Appl. No.: 12/873,916

(22) Filed: Sep. 1, 2010

Related U.S. Application Data
(60) Provisional application No. 61/339,812, filed on Mar. 8, 2010.

(51) Int. Cl. A45C 11/20; B31B 17/00

(52) U.S. Cl. 206/541; 493/84

(57) ABSTRACT

A sandwich container includes an outer housing. The outer housing includes a tray compartment body and a lid compartment body. The tray compartment body is hingedly connected to the lid compartment body. The tray compartment body defines a tray compartment and the lid compartment body defines a lid compartment. The sandwich container also includes a divider hingedly connected to the outer housing. The divider is rotatable from an unseated position to a seated position. The divider is configured to separate the tray compartment from the lid compartment when the divider is in the seated position.

### CROSS REFERENCE TO RELATED APPLICATIONS

This application claims the priority of Provisional Patent Application Ser. No. 61/339,812, entitled “DUAL COMPARTMENT SANDWICH CONTAINER WITH A ROTATABLE FLEXIBLE BI-STABLE DIVIDER”, which was filed on Mar. 8, 2010 and which is hereby incorporated by reference in its entirety.

### BACKGROUND OF THE INVENTION

This invention relates generally to food storage containers, and specifically to a reusable sandwich container having multiple compartments for housing a plurality of food-related products.

Many workers have elected to bring their lunch from home in a bag or container rather than incur the cost and time associated with eating out. Also, many parents elect to prepare and send lunch to school with their children. Moreover, many people elect to attend picnics and other functions and further elect to bring their own meals. Many known food containers are large enough to be used to contain a sandwich for future consumption. However, because there is usually a long time delay between the preparation and consumption of a sandwich, many sandwiches prepared a period of time prior to consumption may become warm and soggy as the dry sandwich bread absorbs liquid from sandwich contents that include meats, condiments, and toppings such as tomatoes and/or lettuce. Such a sandwich may fall apart or become difficult to consume. Moreover, without refrigeration, over a period of time prior to consumption, the sandwich ingredients will approach ambient temperatures, thereby causing the sandwich to be less appealing. Further, the freshness of the ingredients may be compromised. If certain ingredients are compromised, the entire sandwich could become significantly comprised and possibly cause serious illness in the event of consumption by a user.

Compartmentalized food containers are known in the art. However, few conventional food containers are suitable to be reused and adequate for protecting a sandwich against being flattened as well as losing its freshness in a relatively short time, especially in warm weather. At least some of the known food containers are soft containers, for example, paper and plastic bags. Such containers provide little to no protection against physical damage to the enclosed sandwich. Also, many of the known food containers are single-use containers, thereby increasing waste stream traffic. Further, although some conventional food containers are known to provide temporary sandwich storage, no food container is known which includes a rotatable fluid-tight divider that is adapted to isolate the relatively dry bread from the relatively wet sandwich ingredients in separate compartments so as to prevent the bread from becoming soggy and inedible between the time that the sandwich container is initially packed and the time that the sandwich is ultimately consumed. More particularly, no sandwich container is known having a divider which can be manipulated to assume different configurations so that the storage capacities of different compartments of the container that are isolated by the divider can be selectively adjusted to carry therewithin either slices of dry bread and the wet ingredients for making a sandwich or a ready-to-eat sandwich where the ingredients are placed between the slices within a larger compartment size. Furthermore, no sandwich container is known having a hollow, removable tray to be located in one of the storage compartments wherein the tray is filled with a thermal gel of the kind to be refrigerated or frozen to create a cold pack to chill the sandwich ingredients and prevent spoilage prior to consumption.

### BRIEF DESCRIPTION OF THE INVENTION

In one aspect, a sandwich container is provided. The sandwich container includes an outer housing. The outer housing includes a tray compartment body and a lid compartment body. The tray compartment body is hingedly connected to the lid compartment body. The tray compartment body defines a tray compartment and the lid compartment body defines a lid compartment. The sandwich container also includes a divider hingedly connected to the outer housing. The divider is rotatable from an unseated position to a seated position. The divider is configured to separate the tray compartment from the lid compartment when the divider is in the seated position.

In another aspect, a food container is provided. The food container includes an outer housing comprising a lower body and an upper body. The lower body is hingedly connected to the upper body. The food container also includes a divider hingedly connected to the outer housing. The divider is rotatable from an unseated position to a seated position. The divider and the upper body define an upper compartment and the divider and the lower body define a lower compartment. The divider is configured to separate the lower compartment from the upper compartment when the divider is in the seated position. The divider is movable while in the seated position to change a size of the upper compartment and the lower compartment.

In yet another aspect, a method of assembling a sandwich container is provided. The method includes forming an outer housing by hingedly coupling a tray compartment body to a lid compartment body. The tray compartment body defines a tray compartment and the lid compartment body defines a lid compartment. The method also includes hingedly coupling a divider to the outer housing. The divider is rotatable from an unseated position to a seated position. The divider is configured to separate the tray compartment from the lid compartment when the divider is in the seated position.

### BRIEF DESCRIPTION OF THE DRAWINGS

FIG. 1 is a first exploded view of an exemplary dual compartment sandwich container having an adjustable divider.

FIG. 2 is a second exploded view of the dual compartment sandwich container shown in FIG. 1.

FIG. 3 is a perspective view of the dual compartment sandwich container shown in FIGS. 1 and 2 in a partially assembled configuration.

FIG. 4 is a perspective view of the dual compartment sandwich container shown in FIGS. 1, 2, and 3 in an assembled open configuration.

FIG. 5 is a perspective view of the dual compartment sandwich container shown in FIGS. 1, 2, 3, and 4 in an assembled closed configuration.

FIG. 6 is a schematic cross-sectional side view of the dual compartment sandwich container shown in FIGS. 1-5 with the adjustable divider in a raised configuration and a removable tray therein.

FIG. 7 is a schematic cross-sectional side view of the dual compartment sandwich container shown in FIGS. 1-5 with the adjustable divider in a recessed configuration and the removable tray therein.

FIG. 8 is a schematic cross-sectional side view of the dual compartment sandwich container shown in FIGS. 1-5 with the adjustable divider in a recessed configuration and no removable tray therein.

FIG. 9 is a perspective view of the dual compartment sandwich container shown in FIGS. 1-8 with a first alternative closing mechanism.

FIG. 10 is a front view of the dual compartment sandwich container shown in FIG. 9;

FIG. 11 is a perspective view of the dual compartment sandwich container shown in FIGS. 1-8 with a second alternative closing mechanism.

FIG. 12 is a perspective view of the dual compartment sandwich container shown in FIGS. 1-8 with a third alternative closing mechanism.

FIG. 13 is a perspective view of an alternative adjustable divider that may be used with the dual compartment sandwich container shown in FIGS. 1-8.

FIG. 14 is a schematic cross-sectional side view of a wiping sealing mechanism that may be used with the adjustable divider shown in FIG. 13.

FIG. 15 is a schematic cross-sectional side view of a compression sealing mechanism that may be used with the adjustable divider shown in FIG. 13.

FIG. 16 is a schematic cross-sectional side view of the adjustable divider shown in FIG. 13 in a lower/recessed stable position.

FIG. 17 is a schematic cross-sectional side view of the adjustable divider shown in FIG. 16 in an upper/raised stable position.

FIG. 18 is a schematic cross-sectional side view of the dual compartment sandwich container shown in FIGS. 1-5 with the alternative adjustable divider shown in FIG. 13 in the upper/raised stable position as shown in FIG. 17 with a removable tray therein.

FIG. 19 is a perspective view of an alternative exemplary embodiment of a dual compartment sandwich container with a plurality of corner members.

### DETAILED DESCRIPTION OF THE INVENTION

The following detailed description illustrates the disclosure by way of example and not by way of limitation. The description clearly enables one skilled in the art to make and use the disclosure, describes several embodiments, adaptations, variations, alternatives, and use of the disclosure, including what is presently believed to be the best mode of carrying out the disclosure.

The effectiveness of a sandwich container can be measured by the temperature and freshness of its sandwich ingredients and the dryness of the bread. The effectiveness of a sandwich container can also be measured by how well it protects the sandwich and/or sandwich ingredients from crushing during transport and storage. Therefore, to be effective, a sandwich storage container should have sufficient strength to reduce a potential for damage to the sandwich. Also, the sandwich storage container should have sufficient strength to withstand repeated use, including repeated washings and openings/closings. Moreover, the sandwich container should provide sufficient internal storage space to either separate the bread slices from the wet ingredients and/or incorporate a mechanism to keep the sandwich ingredients cool and fresh. Furthermore, the sandwich container should facilitate ease of cleaning after each use and then be reused so as to reduce waste.

The sandwich containers described herein, and the methods of assembling such sandwich containers, facilitate storage and transport of sandwiches and sandwich materials. Specifically, the sandwich containers are assembled to maintain a freshness and/or a temperature of a completed sandwich, or the ingredients therein. Also, specifically, the sandwich containers are assembled to maintain the bread in a dry state. More specifically, the sandwich containers described herein provide sufficient internal storage space to either separate the bread slices from the wet ingredients and/or a mechanism to keep the sandwich ingredients cool and fresh. Further, specifically, the sandwich containers are assembled to protect the sandwich and/or sandwich ingredients from crushing during transport and storage. Therefore, the sandwich storage containers described herein have sufficient strength to reduce a potential for damage to the sandwich and to withstand repeated use, including repeated washings. Moreover, the sandwich containers described herein include components that facilitate ease of converting the sandwich containers from storage for sandwich components to storage for ready-to-eat sandwiches with only minor adjustments of the configuration of the sandwich containers. Furthermore, the sandwich containers described herein facilitate ease of cleaning after each use and are then to be reused so as to reduce waste. In alternative embodiments, materials may be used that facilitate fabricating a disposable sandwich container with at least some of the features of the sandwich containers described herein.

Moreover, the containers described herein are substantially sized and configured for sandwiches for exemplary purposes only and are not intended to limit the use of such containers to merely sandwiches. Therefore, the containers described herein are not limited to sandwiches and can be used to house any food product.

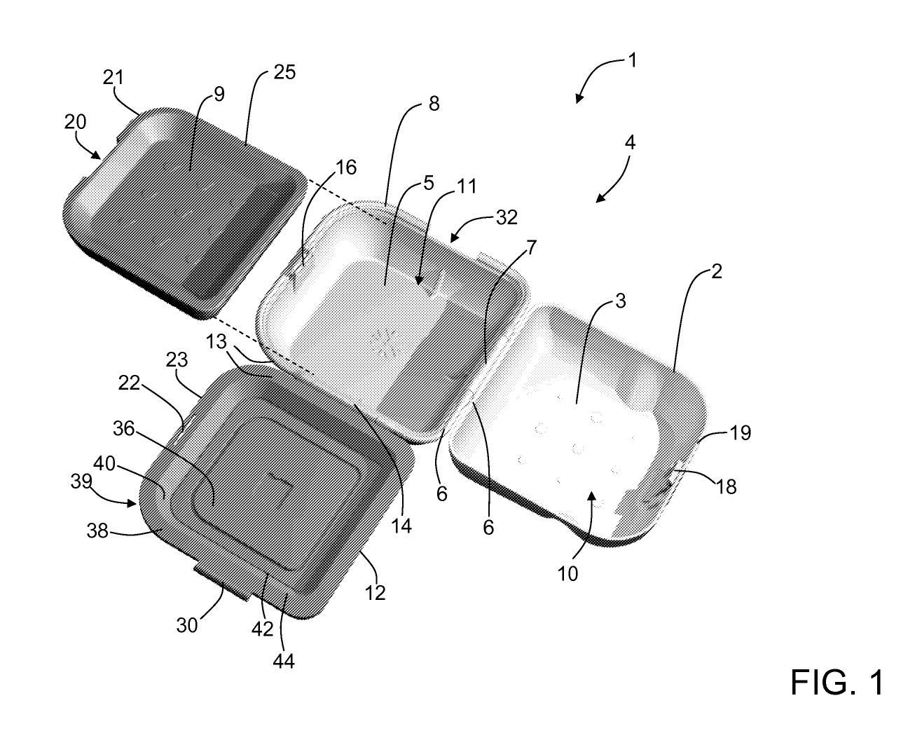

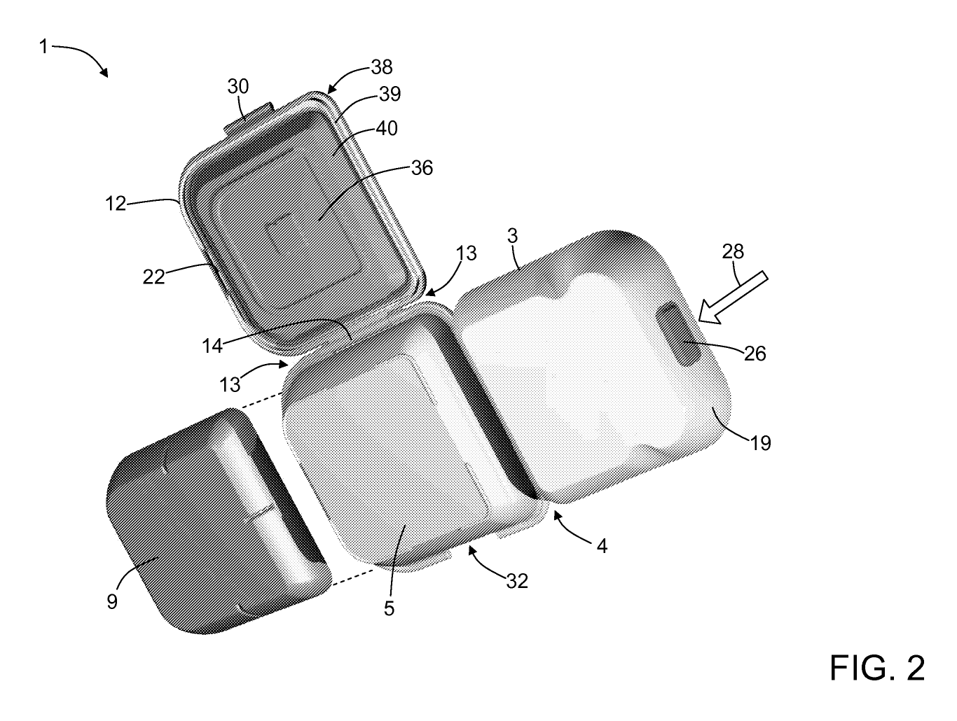

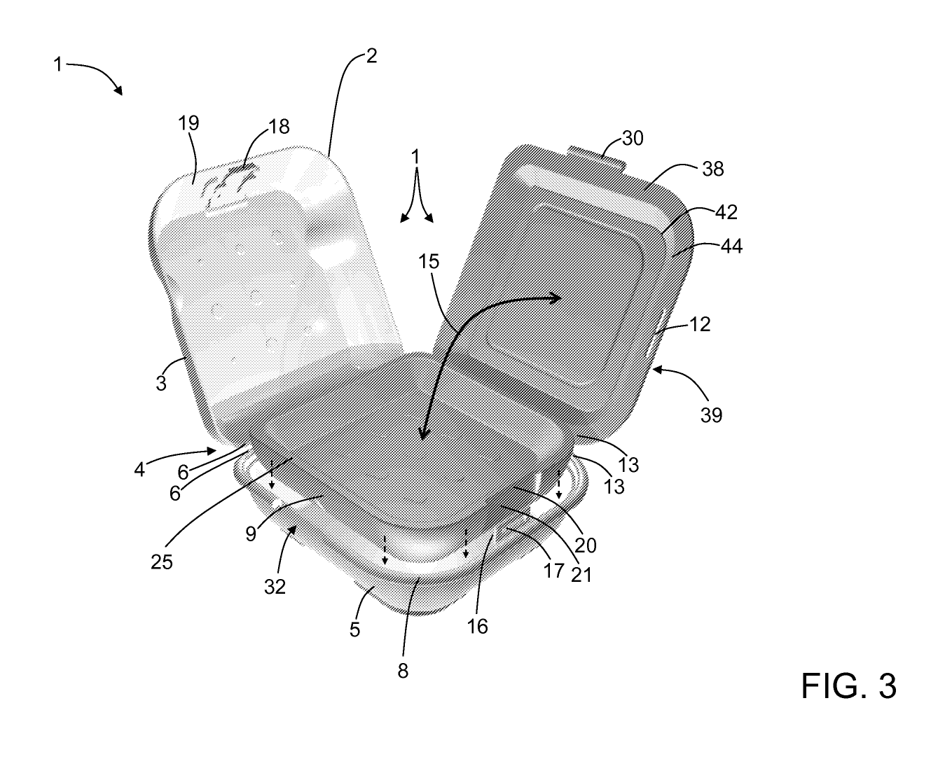

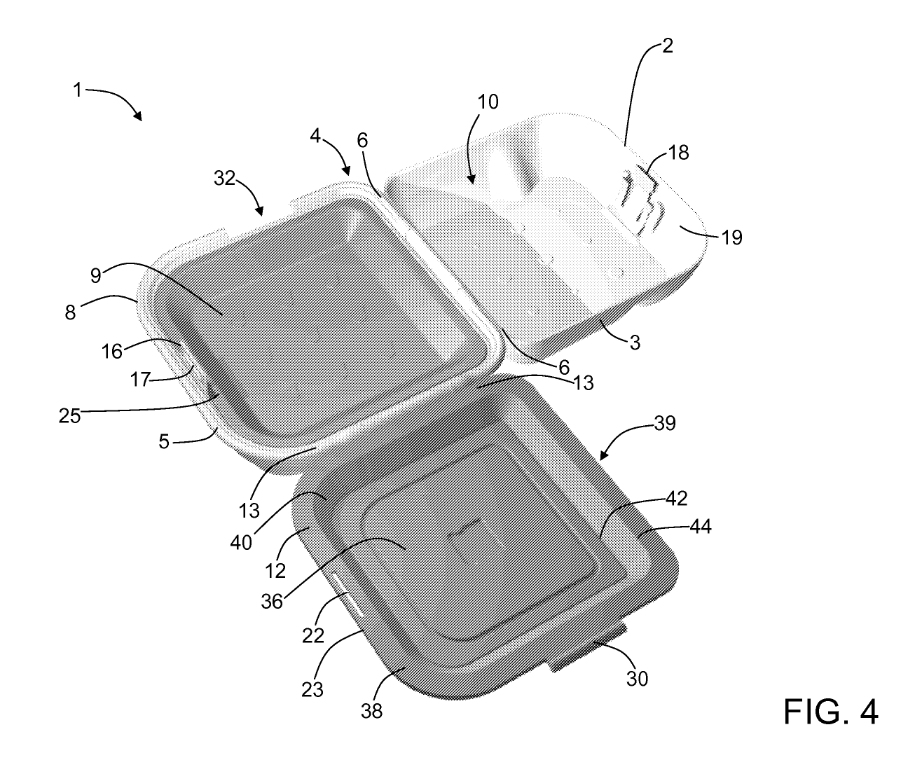

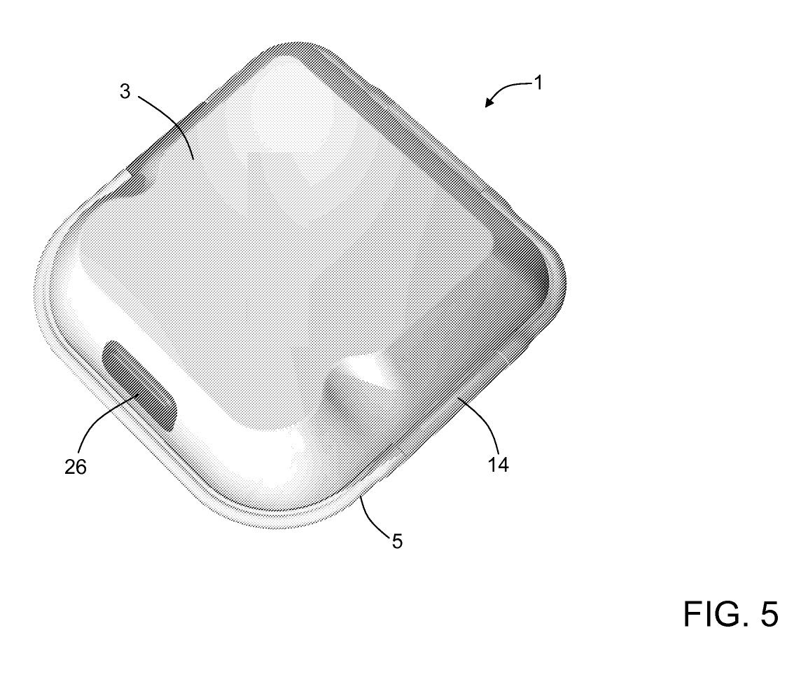

FIG. 1 is a first exploded view of an exemplary dual compartment sandwich container 1 having an adjustable divider 12. FIG. 2 is a second exploded view of dual compartment sandwich container 1. FIG. 3 is a perspective view of dual compartment sandwich container 1 in a partially assembled configuration. FIG. 4 is a perspective view of dual compartment sandwich container 1 in an assembled open configuration. FIG. 5 is a perspective view of dual compartment sandwich container 1 in an assembled closed configuration.

In the exemplary embodiment, dual compartment sandwich container 1 includes an outer housing 4 that includes an upper compartment body 3 and a lower compartment body 5, wherein both bodies 3 and 5 are hingedly coupled to each other along respective and opposing rear edges 6 by a hinge 7 extending therebetween. Upper compartment body 3, hereon referred to as upper body 3, defines an upper compartment 10 and lower compartment body 5, hereon referred to as lower body 5, defines a lower compartment 11. Also, in the exemplary embodiment, lower compartment 11 may receive a removable tray 9. Upper body 3 and lower body 5 define a clam-shell-shaped configuration of container 1. Upper compartment 10 is sometimes referred to as the lid or top compartment. Lower compartment 11 is sometimes referred to as a tray or bottom compartment. Upper body 3 includes a rim 2 that defines a perimeter extending around an outer edge of upper compartment 10. Also, lower body 5 includes a rim 8 that defines a perimeter extending around an outer edge of lower compartment 11.

Further, in the exemplary embodiment, removable tray 9 defines a cavity therein (not shown in FIGS. 1-5) in which a thermal gel (not shown in FIGS. 1-5) is stored. The thermal gel is substantially similar to that found in a commercially-available cold pack and is adapted to maintain a low temperature (i.e., a temperature below a predefined temperature) for an extended period of time after first being refrigerated or frozen. Moreover, the thermal gel may also be adaptable to maintain an elevated temperature (i.e., a temperature above a predefined temperature) after first being heated. Therefore, the thermal gel inside removable tray 9 facilitates maintaining the sandwich ingredients approximately at a desired temperature to reduce a potential for spoilage when the sandwich will not be immediately consumed. As described below, the storage capacity of upper compartment 10 may be selectively adjusted to hold either two slices of bread or a complete sandwich (neither shown in FIGS. 1-5).

In the exemplary embodiment, sandwich container 1 is substantially formed of durable plastic and/or rubber compounds having a size and shape that facilitate receipt and transport of two slices of dry bread and wet ingredients for making a typical sandwich. Alternatively, sandwich container 1 is formed of any materials that enable operation of sandwich container 1 as described herein. Such materials facilitate durability of container 1, reduce a potential of damage to ingredients placed therein during handling and transport of container 1, and are washable and reusable.

Also, in at least one embodiment, removable tray 9 is formed such that air gaps (not shown) may be formed in the vicinity of the perimeter and/or the lower surface of removable tray 9 to further provide at least some insulating features to reduce a potential for formation of condensation within, and on the exterior of, sandwich container 1. Accordingly, removable tray 9 is configured to reduce a potential for introduction of liquids to any dry bread slices (not shown in FIGS. 1-5) that may be introduced into sandwich container 1.

Further, in the exemplary embodiment, dual compartment sandwich container 1 includes an adjustable divider 12, that is, specifically, a rotatable, flexible bi-stable divider 12 located between upper and lower compartments 10 and 11, respectively. In the exemplary embodiment, and as discussed further below, divider 12 is sized to be complementary to removable tray 9. Divider 12 is manufactured from silicone rubber, thermoplastic elastomer (TPE) or any suitable elastomeric material that enables operation of sandwich container 1 as described herein. Moreover, divider 12 is manufactured from any materials that enable operation of sandwich container 1 as described herein.

Divider 12 has flexibility characteristics that facilitate selectively changing divider 12 to one of two stable configurations, each described further below, as a function of the contents to be carried within upper and lower compartments 10 and 11, respectively, as discussed further below. Alternatively, divider 12 is manufactured from any material that enables operation of sandwich container 1 including, without limitation, hard plastics. Adjustable divider 12 is hingedly coupled to lower body 5 along respective and opposing edges 13 of lower body 5 and divider 12 by a hinge 14. Divider 12 is adapted to rotate at hinge 14 in either of the directions indicated by a directional arrow 15 (only shown in FIG. 3) between an unseated or raised position lying outside lower body 5 (as shown in FIG. 3) and a seated position lying overtop lower compartment 11 and removable tray 9 located therein. Therefore, the dry slices of bread carried in upper compartment 10 and any wet sandwich ingredients in lower compartment 11 are segregated from one another to significantly reduce a potential of migration of liquids and moisture therebetween.

Dual compartment sandwich container 1 also includes a hard plastic locking tang 16 that extends upwardly from a front of lower body 5 opposite hinge 7. An open window 17 is defined within locking tang 16 (shown in FIG. 3). Sandwich container 1 further includes a flexible locking clasp 18 located inside upper compartment 10 at a front portion 19 thereof and opposite hinge 7. Also, removable tray 9 includes a rim 25 that defines a notch 20 at a front portion 21 of removable tray 9. Divider 12 defines a locking slot 22 within a front portion 23 of divider 12.

In the assembled and closed sandwich container configuration, tray 9 is removably received within lower compartment 11 and divider 12 is rotated at hinge 14 from its unseated position to its seated position in order to cover tray 9 and thereby form a substantially air and moisture-tight barrier to isolate upper and lower compartments 10 and 11, respectively, from each another. Moreover, upper body 3 is rotated at hinge 7 towards lower body 5 to extend over divider 12. Locking slot 22 of divider 12 is substantially aligned with locking tang 16, extending from lower body 5. As upper body 3 is rotated over divider 12, flexible locking clasp 18 of upper body 3 will first be bent by hard plastic locking tang 16 to store energy and then snap into detachable locking engagement with locking tang 16 at open window 17 formed therein. That is, flexible locking clasp 18 has a spring memory that induces clasp 18 to release stored energy such that it snaps into, and maintains detachable locking engagement with, locking tang 16 whenever sandwich container 1 is fully closed. While locking clasp 18 engages locking tang 16, sandwich container 1 will be held in the closed (and locked) configuration (as shown in FIG. 5) to prevent upper body 3 from inadvertently rotating off and away from lower body 5.

Dual compartment sandwich container 1 further includes an integral push button 26 formed at an exterior portion of front portion 19 of upper body 3 and is operatively coupled to locking clasp 18. Push button 26 is preferably manufactured from a resilient material which may be momentarily compressed, such that a manual pushing force applied thereto in the direction of a directional arrow 28 (only shown in FIG. 2) is transmitted to locking clasp 18. Push button 26 is configured to disengage locking clasp 18 from locking tang 16. Flexible locking clasp 18 is correspondingly pushed away from window 17 and out of its locking engagement with locking tang 16 of lower body 5. Sandwich container 1 may now be opened to gain access to the interior thereof and to the sandwich bread and ingredients. When the pushing force is removed therefrom, the initial pre-compression shape of push button 26 is substantially automatically restored.

Dual compartment sandwich container 1 also includes a lifting lip 30 integrally formed with divider 12, wherein lifting lip 30 extends from divider 12 opposite hinge 14. A lifting slot 32 is formed in lower body 5 opposite hinge 14, wherein slot 32 receives lifting lip 30 when divider 12 is closed upon lower body 5. Specifically, when divider 12 is rotated at hinge 14 towards lower body 5 to its seated position covering tray 9, lifting lip 30 will be removably received within lifting slot 32. Thus, lifting lip 30 will be conveniently accessible to receive a lifting force applied thereto when it is desirable to rotate divider 12 away from lower body 5 and towards its unseated position (as shown in FIG. 3).

Divider 12 includes a plurality of segments that are each coupled together at an associated hinge mechanism. Specifically, the plurality of segments of divider 12 include a flat traverse member, or base 36, a peripheral inner lip, or inner rim 38, a peripheral outer lip, or outer rim 39 opposite to rim 38, and a sloping intermediate wall 40 extending between base 36 and rim 38. Divider inner rim 38 and outer rim 39 define a perimeter extending around an outer edge of divider 12. Regardless of the disposition of removable tray 9, that is, inserted or not inserted within sandwich container 1, when divider 12 is moved to a closed position, divider inner rim 38 contacts lower body rim 8 and forms a seal thereon.

Moreover, divider 12 includes a first and a second hinge mechanism, that is, a first and a second thin reversing crease 42 and 44, respectively. Reversing creases 42 and 44 are configured and positioned such that the segments, that is, base 36, rim 38, and wall 40 can be displaced relative to one another, whereby divider 12 can be manipulated by the user to either one of a stable upper, or raised cap position/configuration, or a stable lower, or recessed dish position/configuration in response to a pressing force applied thereto. More specifically, reversing creases 42 and 44 are portions of divider 12 that are made of substantially similar materials as adjoining portions of divider 12, however, reversing creases 42 and 44 are thinner than such adjoining portions, thereby at least partially weakening those portions of divider 12 defined by reversing creases 42 and 44. Also, specifically, flat base 36 is hingedly coupled to intermediate wall 40 by reversing crease 42 therebetween and intermediate wall 40 is hingedly coupled to peripheral rim 38 by reversing crease 44 therebetween. Therefore, in the exemplary embodiment, a storage capacity of lower compartment 11 can be selectively adjusted to receive removable tray 9 with or without the wet ingredients for making a sandwich lying therein. Moreover, adjustable divider 12 facilitates forming a substantially air and moisture-tight barrier between upper and lower compartments 10 and 11, respectively. In the exemplary embodiment, divider 12 includes two reversing creases. Alternatively, divider 12 includes any number of reversing creases that enable operation of divider 12 as described herein.

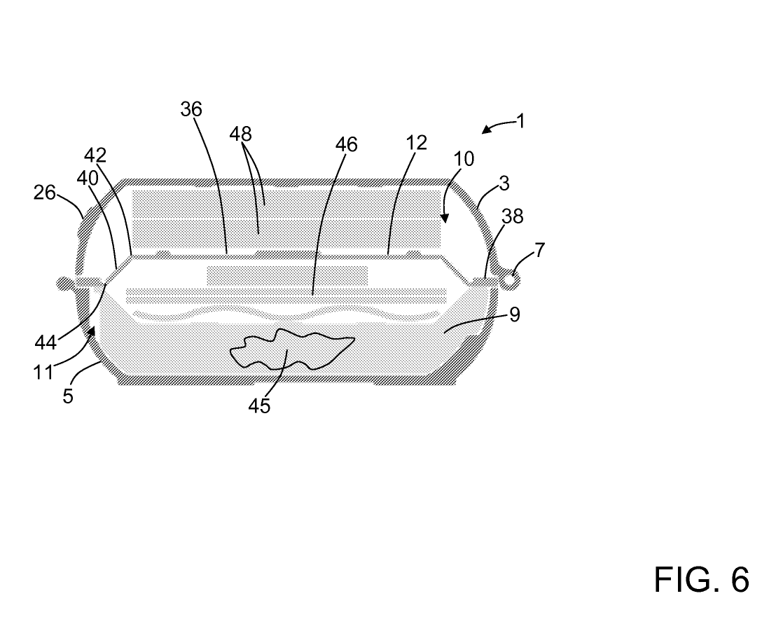

FIG. 6 is a schematic cross-sectional side view of dual compartment sandwich container 1 with adjustable divider 12 in a raised configuration and removable tray 9 removably received within lower compartment 11. Tray 9 is filled with a thermal gel 45, such thermal gel 45 being substantially similar to that found in a commercially-available cold pack and is adapted to maintain a low temperature (i.e., a temperature below a predefined temperature) for an extended period of time after first being refrigerated or frozen. Therefore, tray 9 and thermal gel 45 within may be refrigerated or frozen to create a cold pack, and tray 9 is preferably recessed so as to receive and chill wet ingredients 46 for making a sandwich. Moreover, thermal gel 45 may also be adaptable to maintain an elevated temperature (i.e., a temperature above a predefined temperature) after first being heated. Therefore, thermal gel 45 inside removable tray 9 facilitates maintaining sandwich ingredients 46 approximately at a desired temperature to reduce a potential for spoilage when the sandwich will not be immediately consumed. Alternatively, rather than thermal gel 45, tray 9 includes any substances that enable operation of tray 9 as described herein including, without limitation, a mixture of water and polymer granules.

Moreover, a plurality of dry slices of sandwich bread 48 are located in upper compartment 10, and divider 12 is rotated to its seated position over tray 9 to segregate dry bread 48 from wet ingredients 46. In order to accommodate tray 9 and sandwich ingredients 46 within lower compartment 11, an upward pushing force is applied to base 36 of divider 12 to cause divider 12 to assume its raised cap configuration. More specifically, reversing crease 42 flexes such that base 36 of divider 12 is moved upwardly relative to peripheral rim 38. At the same time, reversing crease 44 flexes so that intermediate wall 40 is also moved upwardly relative to peripheral rim 38 to increase the size and storage capacity of lower compartment 11.

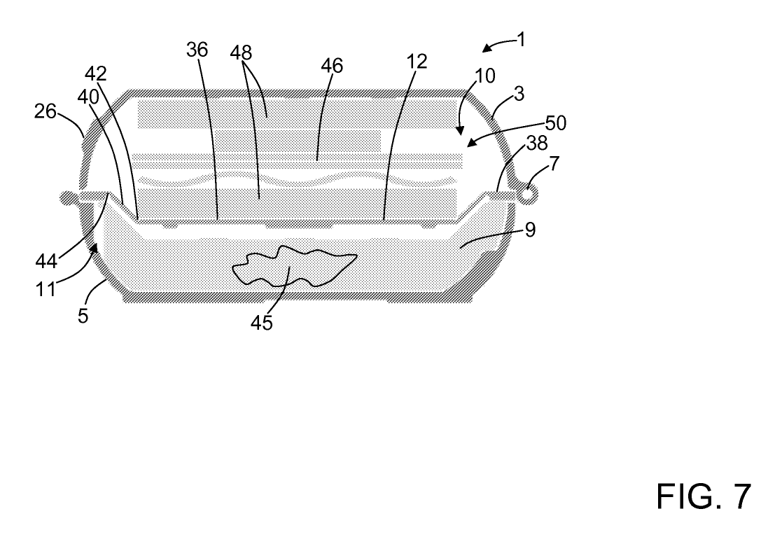

FIG. 7 is a schematic cross-sectional side view of dual compartment sandwich container 1 with adjustable divider 12 in a recessed configuration and removable tray 9 removably received within lower compartment 11. In the exemplary embodiment, a ready-to-eat sandwich 50, including ingredients 46 placed between slices of bread 48, is located in upper compartment 10, and divider 12 is rotated to its seated position to support sandwich 50 thereon. In order to accommodate sandwich 50 within upper compartment 10, a downward pushing force is applied to base 36 of divider 12 to induce divider 12 to assume its recessed dish configuration. Thus, reversing crease 42 flexes such that base 36 of divider 12 moves downwardly relative to peripheral rim 38. At the same time, reversing crease 44 flexes such that intermediate wall 40 also moves downwardly relative to peripheral rim 38 to increase the size and storage capacity of upper compartment 10.

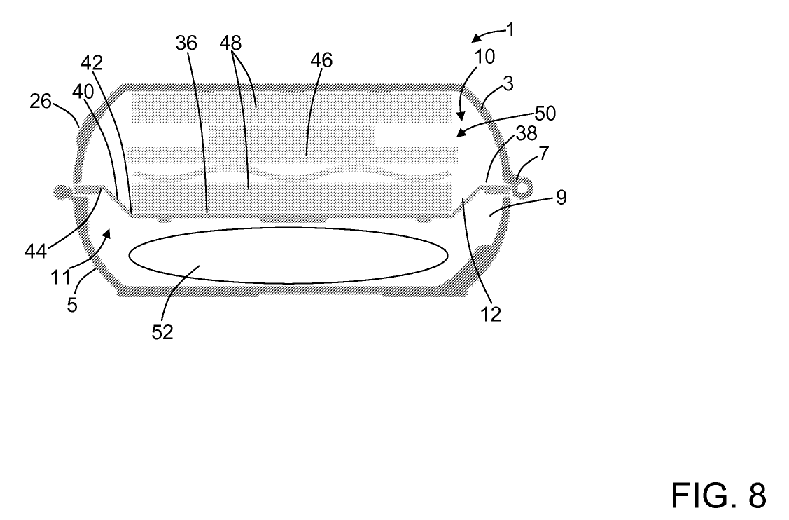

FIG. 8 is a schematic cross-sectional side view of dual compartment sandwich container 1 with adjustable divider 12 in a recessed configuration and no removable tray 9 therein. Also, dual compartment sandwich container 1 with divider 12 is rotated to its seated position and complete ready-to-eat sandwich 50 is located in the upper compartment 10. Divider 12 is shown in its recessed dish configuration to support sandwich 50, however, tray 9 has been removed from lower compartment 11 such that lower compartment 11 is now empty. Lower compartment 11 can be filled with pickles, chips, or the like, to complement sandwich 50 in upper compartment 10. As another option, following its refrigeration, tray 9 (shown in FIG. 7) may be returned to lower compartment 11 to be transported within container 1. Alternatively, a conventional soft gel cold pack 52 can be substituted for tray 9 in lower compartment 11 to chill sandwich 50 in upper compartment 10.

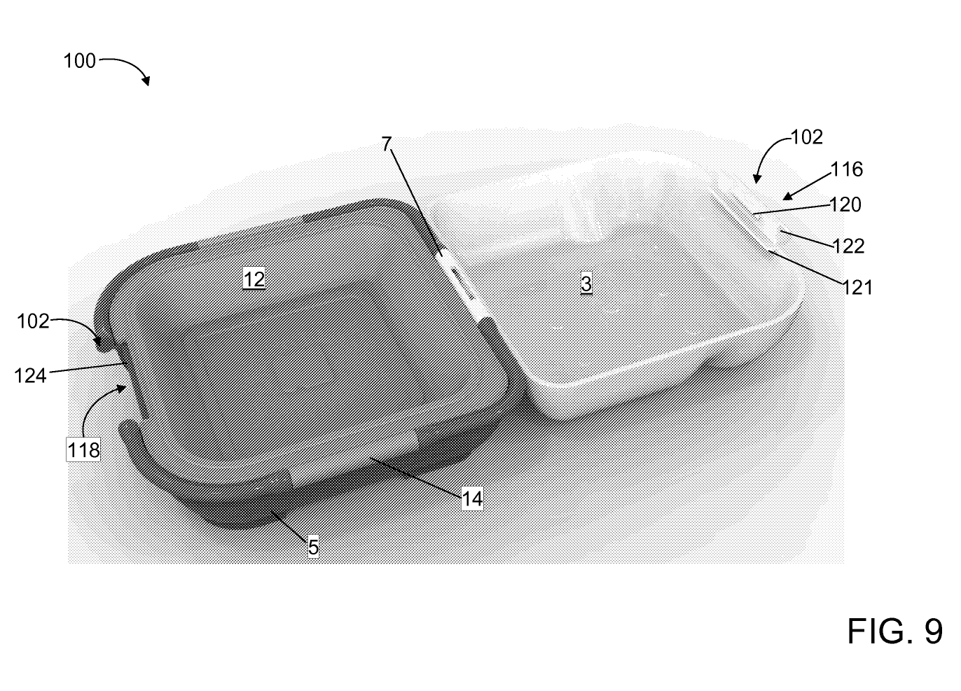

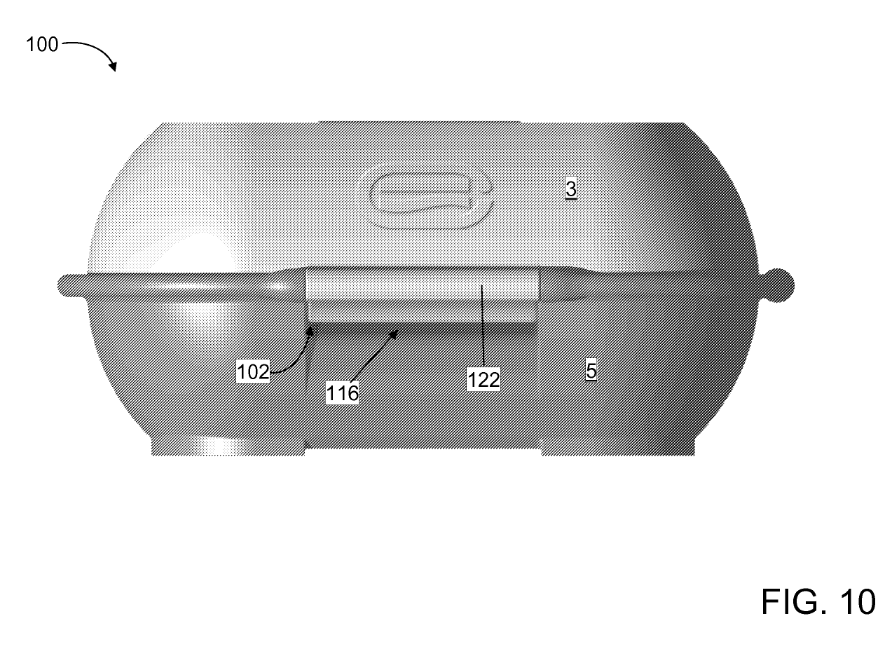

FIG. 9 is a perspective view of a dual compartment sandwich container 100 that is substantially similar to container 1 (shown in FIGS. 1-8) with a first alternative closing mechanism 102. FIG. 10 is a front view of sandwich container 100. First alternative closing mechanism 102 is a hook-latch-type mechanism that includes a locking tang 116 and a complementary locking slot 118 defined by both lower body 5 and adjustable divider 12, wherein locking tang 116, when inserted into locking slot 118, facilitates closing and sealing sandwich container 100. Locking tang 116 includes an upper latching lip 120, a lower latching lip 121, and a finger portion 122. In the exemplary embodiment, upper latching lip 120 and finger portion 122 form a unity piece. Locking slot 118 is at least partially defined by at least one latching surface and/or protrusion 124. Finger portion 122 is configured and oriented to facilitate accommodation of a user's fingers. To close mechanism 102, as upper body 3 is closed over lower body 5 via hinge 7, a user presses on upper body 3 or on locking tang 116 of closing mechanism 102 to engage latching surface/protrusion 124 by engaging upper latching lip 120 therewith. To open mechanism 102, a user simply uses a finger to “pull” on finer portion 122 to disengage from latching surface and/or protrusion 124.

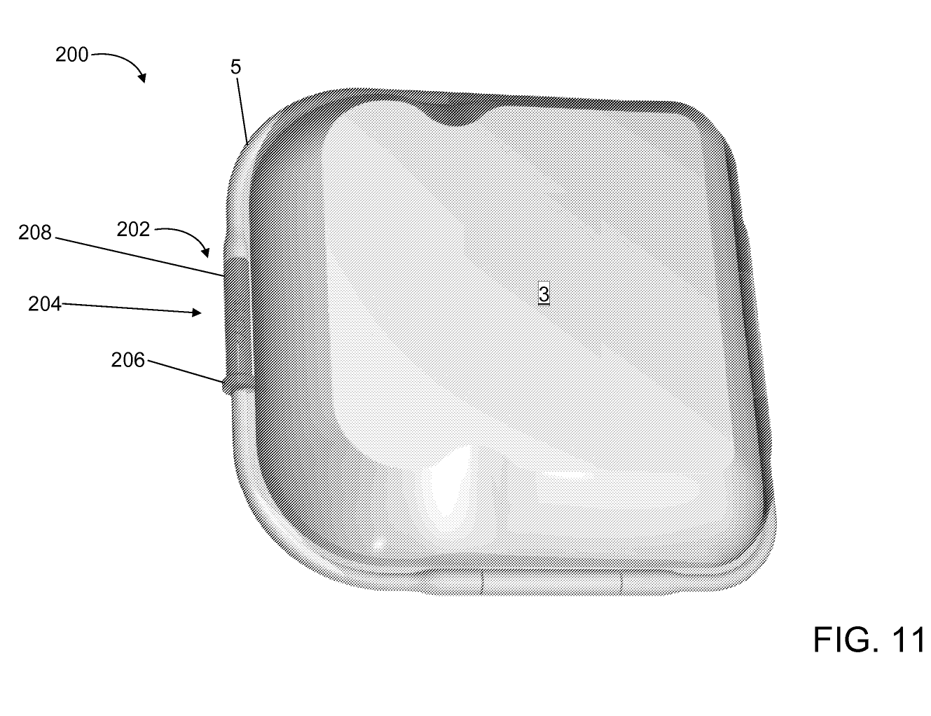

FIG. 11 is a perspective view of a dual compartment sandwich container 200 that is substantially similar to container 1 (shown in FIGS. 1-8) with a second alternative closing mechanism 202. Mechanism 202 is a barrel slide latch mechanism that includes a finger portion, or a finger grip 204 that engages a portion of lower body 5. Finger grip 204 includes a finger protrusion 206 and a barrel portion 208 that are unitarily formed together. Finger grip 204 is configured to slide over a portion of lower body 5, wherein finger grip 204 closes, or clamps thereon. To open container 200, a user pulls on finger grip 204, preferably finger protrusion 206, such that barrel portion 208 pulls away from lower body 5. To close container 200, the user pushes finger grip 204 such that barrel portion 208 slides onto and clamps onto lower body 5.

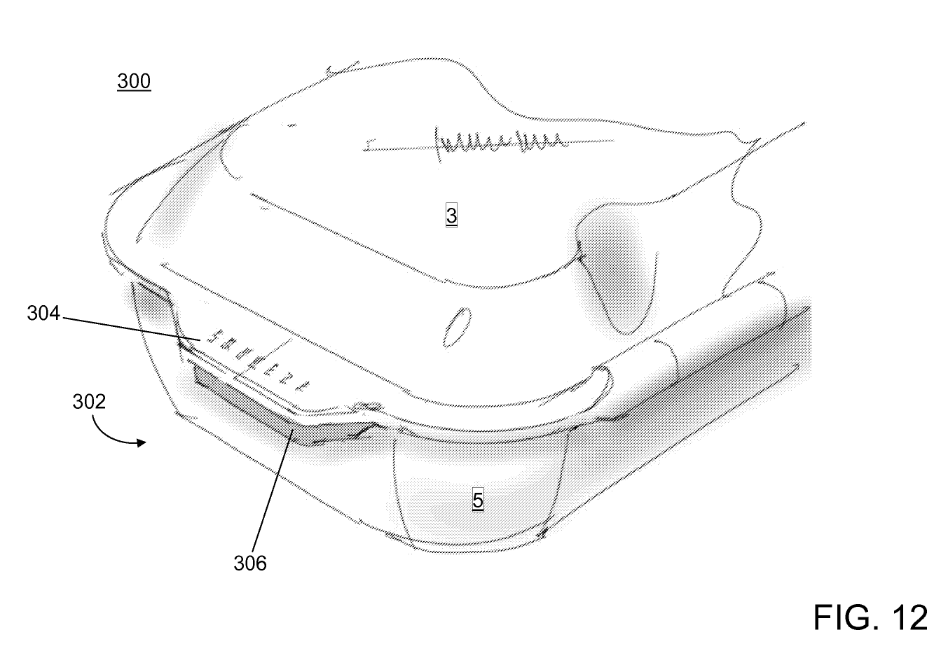

FIG. 12 is a perspective view of a dual compartment sandwich container 300 that is substantially similar to container 1 (shown in FIGS. 1-8) with a third alternative closing mechanism 302. Mechanism 302 is a compression device that includes a stationary upper protruding tab 304 that is unitarily formed with upper body 3. Mechanism 302 also includes a squeezable complementary lower compressible portion 306 that is coupled to or unitarily formed with lower body 5. Portion 306 is squeezed against/towards tab 304 to open portion 302. Portion 304 is pushed down against lower body 5 to trigger a locking mechanism (not shown) to close container 300.

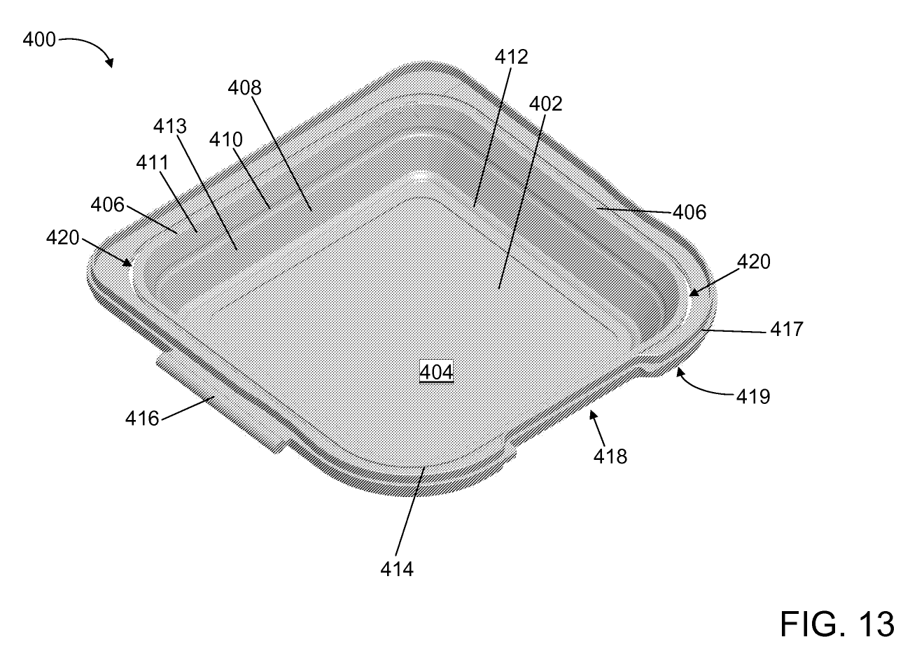

FIG. 13 is a perspective view of an alternative adjustable divider 400 that may be used with dual compartment sandwich container 1 (shown in FIGS. 1-8). In this exemplary alternative embodiment, divider 400 includes a transverse member 402 that is sometimes referred to as the bucket and/or the base. Transverse member 402 is manufactured from a hard plastic, for example, but without limitation, polypropylene that facilitates resiliency and supportive strength and stability to a surface 404 of transverse member 402. Alternatively, transverse member 402 is manufactured from materials that include, without limitation, TPE, or a similar material. Divider 400 also includes an inner rim 406 that defines an inner periphery of divider 400. Divider 400 further includes a wall 408 extending between transverse member 402 and inner rim 406. Wall 408 and inner rim 406 are formed unitarily and are manufactured from a stiff, hard rubber having a shore value of approximately 60 to 80, for example, but without limitation, TPE, or a similar material. Shore, or shore hardness, is a unitless value that measures a resistance of material to indentation, that is, a stiffness of the material, and the higher the shore value, the greater the resistance to indentation, therefore the greater the stiffness and/or hardness of the material.

Moreover, divider 400 includes a pair of reversing creases, that is, an upper reversing crease 410 and a lower reversing crease 412 that are substantially similar to continuous reversing creases 42 and 44 (shown in FIGS. 1, 3, 4, 6, 7, and 8). Reversing creases 410 and 412 are configured and positioned such that transverse member 402, inner rim 406, and wall 408 can be displaced relative to one another, whereby divider 400 can be manipulated by the user to either one of a stable upper, or raised cap position/configuration, or a stable lower, or recessed dish position/configuration in response to a pressing force applied to surface 404. Reversing creases 410 and 412 are portions of wall 408 that are made of substantially similar materials as adjoining portions of wall 408, however, creases 410 and 412 are thinner than such adjoining portions, thereby at least partially weakening those portions of divider 400 defined by creases 410 and 412. Therefore, transverse member 402 is hingedly coupled to wall 408 by reversing crease 412 therebetween.

In this exemplary alternative embodiment, each of creases 410 and 412 are configured to have a concave/convex shape (from an inward/outward perspective, respectively) with respect to wall 408, thereby defining a slight bend in wall 408 in the immediate vicinities of creases 410 and 412. Such slight bend and concave shape facilitates inducing a biasing within each of crease 410 and 412, thereby facilitating reducing mechanical stresses induced therein and increasing longetivity and durability of creases 410 and 412 throughout a multitude of user manipulation between the two aforementioned positions/configurations. Crease 410 separates wall 408 into an upper wall 411 between crease 410 and inner rim 406 and a lower wall 413 between crease 410 and lower crease 412.

Divider 400 also includes an outer rim 414 that defines an outer periphery of divider 400, wherein outer rim 414 includes a lifting latch 416, similar to lifting lip 30 (shown in FIGS. 1-4), formed unitarily thereon, a latch recess 418 defined therein, an upper sealing lip 417 and a lower sealing lip 419, both sealing lips 417 and 419 extending about the outer periphery of divider 400. Outer rim 414 is manufactured from a TPE that is a less stiff, more flexible rubber than the TPE used to manufacture wall 408 and inner rim 406, wherein the TPE for outer rim 414 has a shore value of approximately 30 to 40. Divider 400 further includes a channel 420 defined between inner rim 406 and outer rim 414 that is sized to receive a plurality of stiffening rings (not shown in FIG. 13), discussed further below.

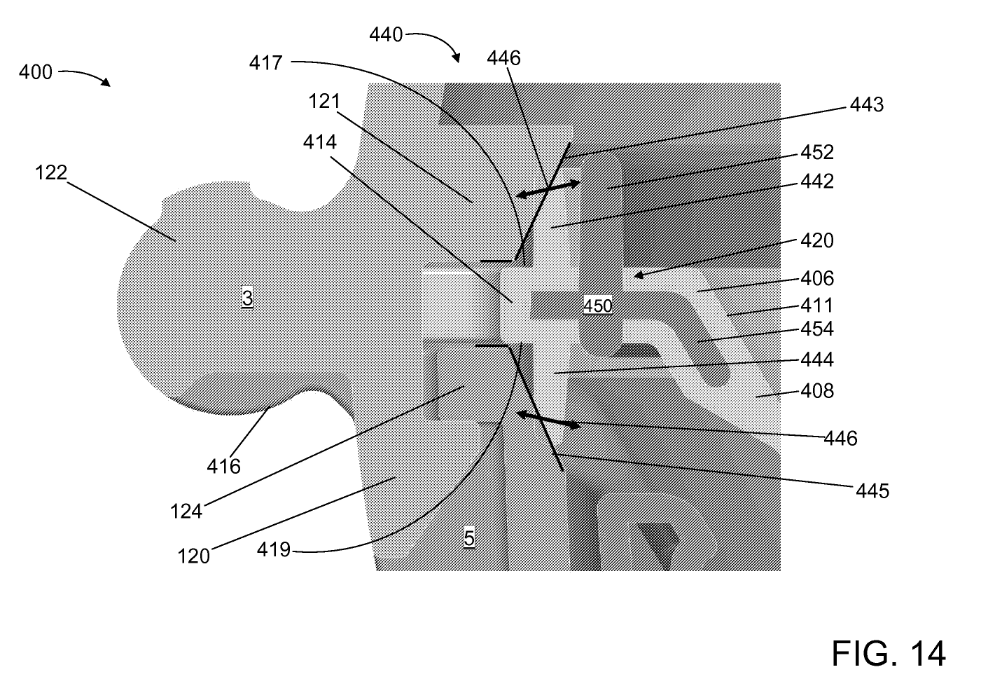

FIG. 14 is a schematic cross-sectional side view of a wiping sealing mechanism 440 that may be used with adjustable divider 400. In this alternative exemplary embodiment, seal mechanism 440 includes portions of inner rim 406 and outer rim 414. Specifically, seal mechanism 440 includes an upper wiping rib 442 and a lower wiping rib 444, both manufactured unitarily with outer rim 414 with TPE having a lesser shore value of approximately 30 to 40. Also, specifically, seal mechanism 440 includes a portion of upper body 3, that is, an upper body sealing surface 443. Further, specifically, sealing mechanism 440 includes a portion of lower body 5, that is, a lower body sealing surface 445. Moreover, specifically, sealing mechanism 440 includes divider upper sealing 417 and divider lower sealing lip 419.

Both wiping ribs 442 and 444 have sufficient flexibility to bend inward as shown by bi-directional arrows 446 when upper body 3 is lowered towards lower body 5, wherein both bodies 3 and 5 are manufactured from a plastic material including, without limitation, polypropylene. Moreover, both wiping ribs 442 and 444 have sufficient flexibility to bend outward to return to their original positions when upper body 3 is raised away from lower body 5 as also shown by bi-directional arrows 446.

Sealing mechanism 440 also includes a reinforcing device, or stiffening ring device 450 that includes an upright ring section 452 and a unitarily-formed lateral ring section 454. Stiffening ring device 450 is manufactured from a plastic material including, without limitation, polypropylene, and facilitates circumferential support and stiffness. Stiffening ring device 450 extends about the entire inner and outer peripheries defined by inner rim 406 and outer rim 414, respectively. Therefore, during an inward flex of wiping rib 442, it wipes, that is, it slides and depresses against upper body sealing surface 443, thereby forming an upper seal. Moreover, during an inward flex of wiping rib 444, it wipes, that is, slides and flexes against lower body sealing surface 445, thereby forming a lower seal. Move over, the upper seal is at least partially formed when upper body sealing surface 443 contacts divider upper sealing lip 417 and the lower seal is at least partially formed when lower body sealing surface 445 contacts divider lower sealing lip 419.

Modulating the stiffness values of TPE used in portions of sealing mechanism 440 facilitates sealing of the sandwich container and shifting between two, or more, positions/configurations. One method of modulating such stiffness includes injection molding techniques, such as overmolding, during fabrication of portions of sealing mechanism 440. Overmolding of a hard material, such as polypropylene, with a more stiff TPE facilitates wall 408 retaining its raised cap position/configuration while facilitating greater durability between configuration changes. An additional overmold of another, less stiff TPE material, facilitates a more flexible seal contact area along outer rim 414, divider upper sealing lip 417, divider lower sealing lip 419, upper wiping rib 442, and lower wiping rib 444. Such sealing mechanism is referred to as a triple-shot sealing mechanism used to describe use of a hard plastic, a stiff TPE rubber, and a less stiff TPE rubber therein.

In addition to functioning as a flexible divider for division of internal compartments 10 and 11, divider 400 also provides seal features between internal compartments 10 and 11 of sandwich container 1. Specifically, in addition to functioning as a multi-position divider, divider 400 may further include two flexible materials of differing hardness/stiffness values such that one of the flexible membrane materials has a higher hardness/stiffness value that is optimized for the function of divider 400 as a multi-position compartment divider and the other flexible material has a softer hardness/stiffness value that is optimized for providing a sealing feature, for example, sealing mechanisms 400 and 440, between divider 400 and outer housing 4 of sandwich container 1.

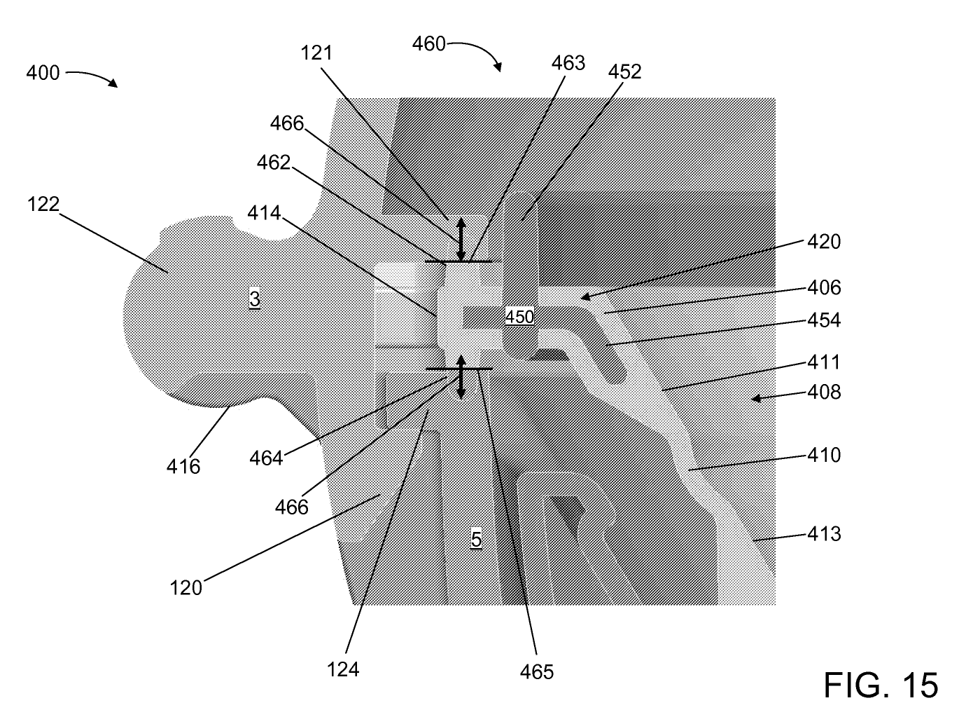

FIG. 15 is a schematic cross-sectional side view of a compression sealing mechanism 460 that may be used with adjustable divider 400. In this alternative exemplary embodiment, seal mechanism 460 includes portions of inner rim 406 and outer rim 414. Specifically, seal mechanism 460 includes an upper compression rib 462 and a lower compression rib 464, both manufactured unitarily with outer rim 414 with TPE having a lesser shore value of approximately 30 to 40. Also, specifically, seal mechanism 460 includes a portion of upper body 3, that is, an upper body sealing surface 463. Further, specifically, sealing mechanism 460 includes a portion of lower body 5, that is, a lower body sealing surface 465.

Both wiping ribs 462 and 464 have sufficient flexibility to bend upward and downward, respectively, as shown by bi-directional arrows 466 when upper body 3 is lowered towards lower body 5, wherein both bodies 3 and 5 are manufactured from a plastic material including, without limitation, polypropylene. Moreover, both compression ribs 462 and 464 have sufficient flexibility to return to their original positions when upper body 3 is raised away from lower body 5 as also shown by bi-directional arrows 466.

Sealing mechanism 460 also includes stiffening ring device 450 that includes upright ring section 452 and unitarily-formed lateral ring section 454, wherein device 450 facilitates circumferential support and stiffness. Stiffening ring device 450 extends about the entire inner and outer peripheries defined by inner rim 406 and outer rim 414, respectively. Therefore, during an inward press of rib 462, it compresses against upper body sealing surface 463, thereby forming an upper seal. Moreover, during an inward press of rib 464, it compresses against lower body sealing surface 465, thereby forming a lower seal.

In a manner substantially similar to sealing mechanism 440 (shown in FIG. 14), sealing mechanism 460 is referred to as a triple-shot sealing mechanism used to describe use of a hard plastic, a stiff TPE rubber, and a less stiff TPE rubber therein.

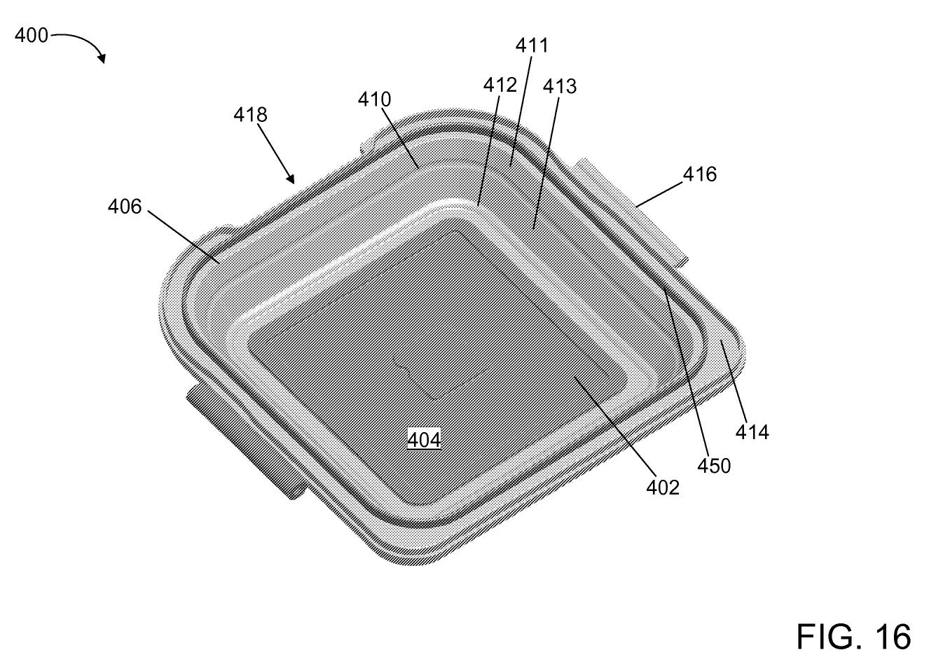

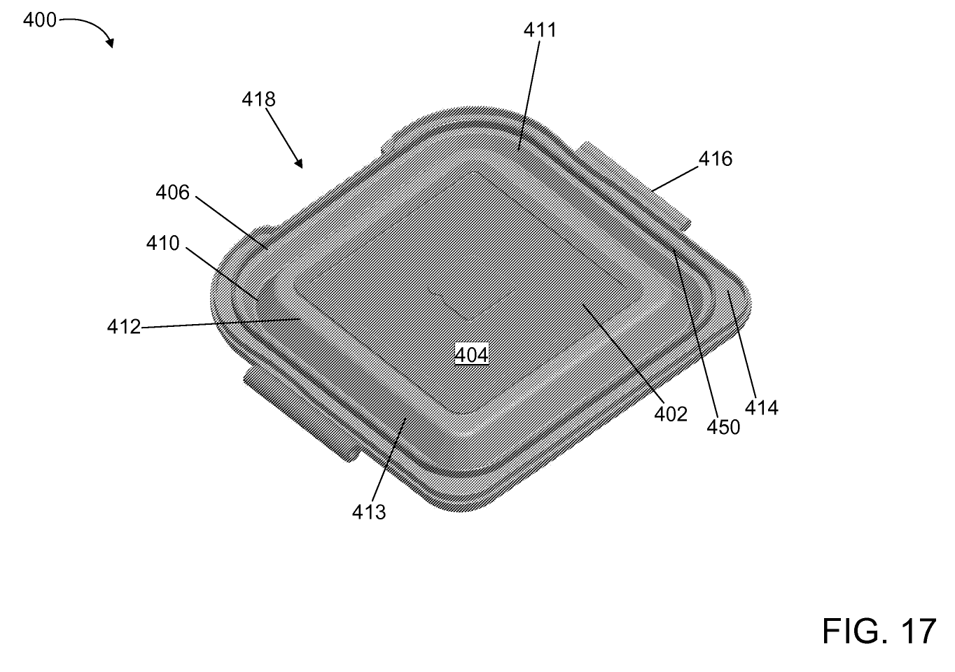

FIG. 16 is a schematic cross-sectional side view of adjustable divider shown 400 in a lower/recessed stable position. FIG. 17 is a schematic cross-sectional side view of adjustable divider 400 in an upper/raised stable position. To change the position/configuration of divider 400 from recessed to raised, a user depresses the bottom of transverse member 402 with sufficient induced force to overcome the biasing induced by creases 410 and 412. Once the threshold bias value is exceeded by the user, lower crease 412 will reverse from a concave configuration with respect to wall 408 to a convex configuration. Also, surface 404 of transverse member 402 will raise with respect to inner and outer rims 406 and 414, respectively. Further, crease 410 will retain a concave configuration with respect to wall 408, however, crease 410 will shift its concavity by approximately 90 degrees as upper wall 411 remains stationary and lower wall 413 shifts from a configuration facing inward towards transverse member 402 to a configuration facing outward from transverse member 402. In the lower/recessed stable position, transverse member 402 is sometimes referred to as the basket and/or the base, wherein transverse member 402 is configured to receive materials that include, without limitation, a whole sandwich or wet sandwich materials. In the upper/raised stable position, transverse member 402 is sometimes referred to as the platform, wherein transverse member 402 is configured to receive materials on surface 404 that include, without limitation, sandwich bread slices.

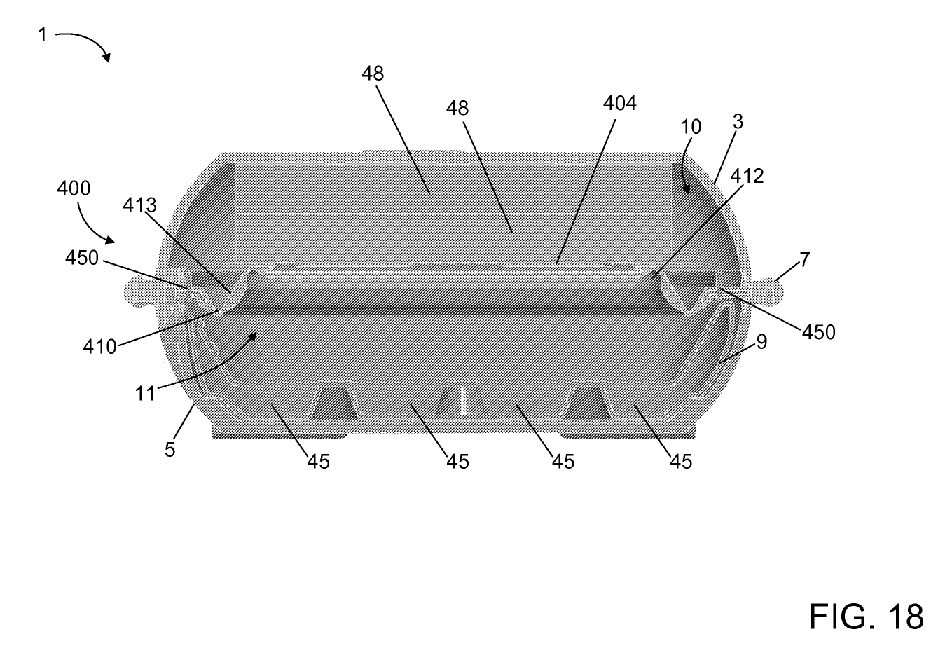

FIG. 18 is a schematic cross-sectional side view of dual compartment sandwich container 1 with alternative adjustable divider 400 in the upper/raised stable position as shown in FIG. 17 with removable tray 9 therein, that is, removable tray 9 is removably received within lower compartment 11. Tray 9 is filled with thermal gel 45, such thermal gel 45 being substantially similar to that found in a commercially-available cold pack and is adapted to maintain a low temperature (i.e., a temperature below a predefined temperature) for an extended period of time after first being refrigerated or frozen. Therefore, tray 9 and thermal gel 45 within may be refrigerated or frozen to create a cold pack, and tray 9 is recessed so as to receive and chill wet ingredients 46 (shown in FIG. 6) for making a sandwich. Moreover, thermal gel 45 is adaptable to maintain an elevated temperature (i.e., a temperature above a predefined temperature) after first being heated. Therefore, thermal gel 45 inside removable tray 9 facilitates maintaining sandwich ingredients 46 approximately at a desired temperature to reduce a potential for spoilage when the sandwich will not be immediately consumed.

Moreover, a plurality of dry slices of sandwich bread 48 are located in upper compartment 10 on top of surface 404, and divider 400 is rotated to its seated position over tray 9 to segregate dry bread 48 from wet ingredients 46. In order to accommodate tray 9 and sandwich ingredients 46 within lower compartment 11, an upward pushing force is applied to transverse member 402 of divider 400 to cause divider 400 to assume its raised stable configuration as described above.

In this exemplary alternative embodiment, adjustable divider 400 divides upper compartment 10, and materials stored therein, from lower compartment 11, and the materials stored therein. Also, divider 400 provides a transverse member 402 that is flexible enough to allow overfilling of lower compartment 11, while rigid enough to support materials on either side of transverse member 402. Such flexibility and rigidity is modulated as a function of the intended commercial use of divider 400. Moreover, divider 400 transitions between two stable configurations, this is, a raised position and a lowered position. Rigid components of divider 400 are manufactured such that a flexible membrane is bonded/overmolded to divider 400 by chemical and/or mechanical bonding processes, such that during manufacturing of divider 400 the flexible membrane and rigid components combine to facilitate assembly of the two materials to form to a higher-level product assembly, that is, outer housing 4 (shown in FIGS. 1 and 4) of sandwich container 1.

In addition to functioning as a flexible divider for division of internal compartment, divider 400 also provides seal features between internal compartments of sandwich container 1. Specifically, in addition to functioning as a multi-position divider, divider 400 may further include two flexible materials of differing hardness/stiffness values such that one of the flexible membrane materials has a higher hardness/stiffness value that is optimized for the function of divider 400 as a multi-position compartment divider and the other flexible material has a softer hardness/stiffness value that is optimized for providing a sealing feature, for example, sealing mechanisms 440 and 460, between divider 400 and outer housing 4 of sandwich container 1.

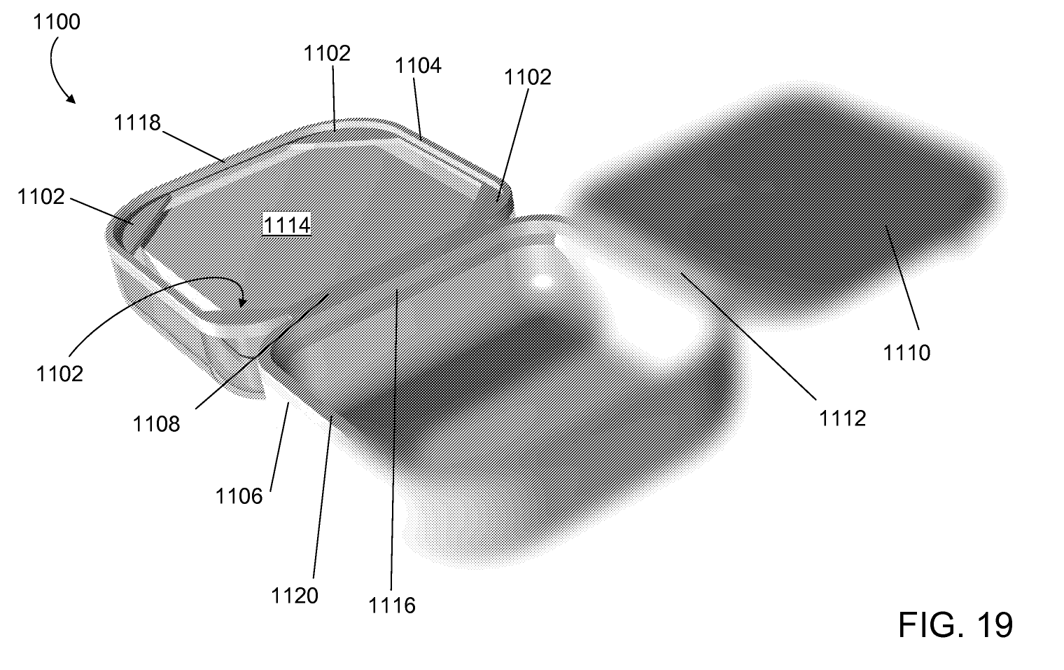

FIG. 19 is a perspective view of an alternative exemplary embodiment of a dual compartment sandwich container 1100 with a plurality of corner members 1102. Sandwich container 1100 includes an upper compartment 1104 and a lower compartment 1106 that are hingedly coupled to each other via a hinging mechanism 1108 at one edge of lower compartment 1106 to facilitate an approximately 180° arcual movement in a plane orthogonal to hinging mechanism 1108. Any hinging mechanism 1108 that enables operation of sandwich container 1100 as described herein is used.

Sandwich container 1100 also includes a hinged divider 1110 that is hingedly coupled to lower compartment 1106 via a hinging mechanism 1112 at one edge of hinged divider 1110 to facilitate an approximately 180° arcual movement in a plane orthogonal to hinging mechanism 1112. Any hinging mechanism 1112 that enables operation of sandwich container 1100 as described herein is used.

In the exemplary embodiment, a plurality of bread slices 1114 are inserted into upper compartment 1104 under corner members 1102 and are at least partially held in place by corner members 1102. Wet ingredients (not shown in FIG. 19) may be placed into lower compartment 1106. Divider 1110 is flipped over such that it contacts and rests upon an inner rim 1116 of lower compartment 1106. Divider 1110 facilitates holding the wet ingredients in place during transit of sandwich container 1100. Divider 1110 also facilitates sealing bread slices 1114 from the wet ingredients. Divider 1110 further facilitates holding bread slices in place during transit. Upper compartment 1104 is folded over such that a sealing surface 1118 of upper compartment 1104 contacts a sealing surface 1120 of lower compartment 1106. Any locking and/or latching mechanism (none shown) that enables operation of sandwich container 1100 as described herein is used. Moreover, hinged divider 1110 and/or lower compartment 1106 including, without limitation, walls and floor therein, may include a thermal gel similar to thermal gel 45 (shown in FIGS. 6 and 7), such thermal gel being substantially similar to that found in a commercially-available cold pack and is adapted to maintain a low temperature (i.e., a temperature below a predefined temperature) for an extended period of time after first being refrigerated or frozen. Therefore, hinged divider 1110, lower compartment 1106, and thermal gel 45 within may be refrigerated or frozen to create a cold pack so as to chill wet ingredients 46 (shown in FIG. 6) for making a sandwich. Moreover, the thermal gel may be adaptable to maintain an elevated temperature (i.e., a temperature above a predefined temperature) after first being heated. Therefore, the thermal gel inside hinged divider 1110 and/or lower compartment 1106 facilitates maintaining sandwich ingredients 46 approximately at a desired temperature to reduce a potential for spoilage when the sandwich will not be immediately consumed.

The sandwich containers described herein, and the methods of assembling such sandwich containers, facilitate storage and transport of sandwiches and sandwich materials. Specifically, the sandwich containers are assembled to maintain a freshness and/or a temperature of a completed sandwich, or the ingredients therein. Also, specifically, the sandwich containers are assembled to maintain the bread in a dry state. More specifically, the sandwich containers described herein provide sufficient internal storage space to either separate the bread slices from the wet ingredients and/or a mechanism to keep an entire assembled sandwich and its ingredients cool and fresh. Further, specifically, the sandwich containers are assembled to protect the sandwich and/or sandwich ingredients from crushing during transport and storage. Therefore, the sandwich storage containers described herein have sufficient strength to reduce a potential for damage to the sandwich and to withstand repeated use, including repeated washings. Moreover, the sandwich containers described herein include components that facilitate ease of converting the sandwich containers from storage for sandwich components to storage for ready-to-eat sandwiches with only minor adjustments of the configuration of the sandwich containers. Furthermore, the sandwich containers described herein facilitate ease of cleaning after each use and then are to be reused so as to reduce waste.

Exemplary embodiments of sandwich containers are described above in detail. The methods, apparatus and systems are not limited to the specific embodiments described herein or to the specific illustrated sandwich containers.

While the invention has been described in terms of various specific embodiments, those skilled in the art will recognize that the invention can be practiced with modification within the spirit and scope of the claims.

What is claimed is:

1. A sandwich container comprising:
an outer housing comprising a tray compartment body and a lid compartment body, said tray compartment body hingedly connected to said lid compartment body, wherein said tray compartment body defines a tray compartment and said lid compartment body defines a lid compartment; and
a divider hingedly connected to said outer housing, said divider rotatable from an unseated position to a seated position, said divider configured to separate said tray compartment from said lid compartment when said divider is in the seated position.

2. A sandwich container in accordance with claim 1, wherein said tray compartment is configured to receive a removable tray member, said removable tray member comprising a thermal gel for maintaining a predetermined temperature within at least said tray compartment.

3. A sandwich container in accordance with claim 1, wherein said divider is received within at least one of said removable tray member, said tray compartment, and said lid compartment.

4. A sandwich container in accordance with claim 1, wherein said divider comprises:
a hinge mechanism for hingedly coupling said divider to said tray compartment body; and
a rim defining a perimeter extending around an outer edge of said divider.

5. A sandwich container in accordance with claim 4, wherein said tray compartment body comprises a rim defining a perimeter extending around an outer edge of said tray compartment body, wherein said tray rim is configured to interface with said divider rim to create a seal between said divider and said tray compartment body.

6. A sandwich container in accordance with claim 4, wherein said lid compartment body comprises a rim defining a perimeter extending around an outer edge of said lid compartment body, wherein said lid rim is configured to interface with said divider rim to create a seal between said divider and said lid compartment body.

7. A sandwich container in accordance with claim 1, wherein said divider comprises a transverse member, a rim defining a perimeter extending around an outer edge of said divider, and a flexible wall extending between said transverse member and said rim, said flexible wall configured to facilitate movement between an upper stable position and a lower stable position of said transverse member.

8. A sandwich container in accordance with claim 7, wherein said flexible wall comprises at least one reversing crease extending around at least one of an outer perimeter and an inner perimeter of said divider rim.

9. A sandwich container in accordance with claim 7, wherein said flexible wall comprises:
an upper wall portion;
a lower wall portion;
an upper reversing crease extending between said upper wall portion and said lower wall portion; and
a lower reversing crease extending between said lower wall portion and said transverse member, said upper reversing crease and said lower reversing crease configured to facilitate movement between the upper stable position and the lower stable position of said transverse member.

10. A sandwich container in accordance with claim 1, wherein said outer housing includes a locking mechanism for securing said tray compartment body and said lid compartment body in a closed condition.

11. A sandwich container in accordance with claim 10, wherein said locking mechanism comprises:
a locking clasp configured to engage with a locking tang; and
a push button operatively coupled to said locking clasp, said push button configured to disengage said locking tang and said locking clasp.

12. A sandwich container in accordance with claim 10, wherein said locking mechanism comprises:
a locking tang comprising at least one latching lip; and
a locking slot configured to receive said locking tang, said locking tang and said locking slot configured to close and seal said sandwich container by engaging said at least one latching lip with a portion of at least one of said tray compartment body when said locking tang is inserted into said locking slot.

13. A sandwich container in accordance with claim 10, wherein said locking mechanism comprises:
a finger grip comprising a finger protrusion;
a barrel portion unitarily formed with said finger protrusion, said barrel portion engaged with said outer housing, said outer housing configured to receive said barrel, wherein said barrel slides onto and clamps onto said outer housing to engage said outer housing to close said locking mechanism and said barrel disengages from said outer housing to open said locking mechanism.

14. A sandwich container in accordance with claim 10, wherein said locking mechanism comprises:
a stationary upper protruding tab unitarily formed with said outer housing; and
a lower compressible portion unitarily formed with said outer housing, wherein said stationary upper protruding tab and said lower compressible portion are complementary, said lower compressible portion is squeezed to open and close said locking mechanism.

15. A sandwich container in accordance with claim 1 further comprising a sealing mechanism comprising:
an upper seal comprising a lid body sealing surface, an upper sealing lip, an upper sealing rib, and a reinforcing member, wherein said upper seal is formed by contact of said lid body sealing surface with said upper sealing lip and said upper sealing rib; and
a lower seal comprising a tray body sealing surface, a lower sealing lip, and a lower sealing rib, wherein said lower seal is formed by contact of said tray body sealing surface with said lower sealing lip and said lower sealing rib.

16. A sandwich container in accordance with claim 15, wherein said divider comprises an inner rim comprising a first material having a first stiffness value, wherein said upper sealing rib and said lower sealing rib comprise a second material having a second stiffness value, wherein the first stiffness value is greater than the second stiffness value.

17. A sandwich container in accordance with claim 1, wherein said tray compartment is configured to receive a removable soft gel pack, said removable soft gel pack comprising a thermal gel for maintaining a predetermined temperature within at least said tray compartment.

18. A food container comprising:
an outer housing comprising a lower body and an upper body, said lower body hingedly connected to said upper body; and
a divider hingedly connected to said outer housing, said divider rotatable from an unseated position to a seated position, wherein said divider and said upper body define an upper compartment and said divider and said lower body define a lower compartment, said divider configured to separate said lower compartment from said upper compartment when said divider is in the seated position, said divider is movable while in the seated position to change a size of said upper compartment and said lower compartment.

19. A method of assembling a sandwich container, said method comprising:
forming an outer housing comprising hingedly coupling a tray compartment body to a lid compartment body, wherein the tray compartment body defines a tray compartment and the lid compartment body defines a lid compartment; and
hingedly coupling a divider to the outer housing, wherein the divider is rotatable from an unseated position to a seated position, the divider is configured to separate the tray compartment from the lid compartment when the divider is in the seated position.

20. A method in accordance with claim 19 further comprising positioning a removable tray member within the tray compartment, the removable tray member includes a thermal gel for maintaining a predetermined temperature within at least the tray compartment.
